(19) United States
(12) Patent Application Publication
(10) Pub. No.: US 2024/0429405 A1
(43) Pub. Date: Dec. 26, 2024

(54) INTERCONNECTOR FOR A STACK OF SOLID SOEC/SOFC-TYPE OXIDE CELLS HAVING TABS WITH OPTIMISED GEOMETRY

(71) Applicant: COMMISSARIAT A L'ENERGIE ATOMIQUE ET AUX ENERGIES ALTERNATIVES, Paris (FR)

(72) Inventors: Stéphane DI IORIO, Grenoble Cedex 09 (FR); Manon ELIE, Grenoble Cedex 09 (FR); Philippe SZYNAL, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/696,160

(22) PCT Filed: Sep. 27, 2022
(86) PCT No.: PCT/FR2022/051815

§ 371 Date: Mar. 27, 2024

(30) Foreign Application Priority Data
Sep. 29, 2021 (FR) 2110285

(51) Int. Cl. H01M 8/0228; C25B 9/70; C25B 13/02; C25B 13/07; H01M 8/021; H01M 8/0217; H01M 8/0258; H01M 8/12; H01M 8/2432

(52) U.S. Cl. CPC H01M 8/0228; C25B 9/70; C25B 13/02; C25B 13/07; H01M 8/021; H01M 8/0217; H01M 8/0258; H01M 8/2432; H01M 2008/1293

(57) ABSTRACT

An interconnector for a stack of SOEC/SOFC type solid oxide cells, configured to be arranged between two adjacent electrochemical cells, is formed by the assembly of at least three plates extending along first and second axes of symmetry, the main plate including holes, and each hole including tabs spaced apart to form a comb. Slots are defined between the edge of a hole and a tab or between two successive tabs. The width of each tab of at least one hole is between 0.1 mm and 3 mm.

### TECHNICAL FIELD

The present invention relates to the general field of high temperature electrolysis (HTE), in particular high temperature steam electrolysis (HTSE), carbon dioxide (CO₂) electrolysis, and even high temperature steam and carbon dioxide (CO₂) co-electrolysis.

More specifically, the invention relates to the field of high-temperature solid oxide electrolysers, usually known by the acronym SOEC (for solid oxide electrolysis cells).

It also relates to the field of high-temperature solid oxide fuel cells, usually known by the acronym SOFC (for solid oxide fuel cells).

Thus, more generally speaking, the invention relates to the field of stacks of SOEC/SOFC type solid oxide cells operating at high temperature.

More specifically, the invention relates to an interconnector for a stack of SOEC/SOFC type solid oxide cells including tabs in holes of a central plate constituting the interconnector with optimised geometry, and a stack of SOEC/SOFC type solid oxide cells comprising a plurality of such interconnectors.

### PRIOR ART

An SOEC type high-temperature solid oxide electrolyser converts water vapour (H₂O) into hydrogen (H₂) or other fuels such as methane (CH₄), natural gas or biogas, and into oxygen (O₂), and/or converts carbon dioxide (CO₂) into carbon monoxide (CO) and oxygen (O₂), by means of an electric current within a single electrochemical device. In an SOFC type high-temperature solid oxide fuel cell, the operation is reversed to produce an electric current and heat by consuming hydrogen (H₂) and oxygen (O₂), typically air and natural gas, i.e. methane (CH₄). For the sake of simplicity, the following description focuses on the operation of an SOEC type high-temperature solid oxide electrolyser performing steam electrolysis. However, this operation can be applied to carbon dioxide (CO₂) electrolysis and even high temperature (HTE) steam and carbon dioxide (CO₂) co-electrolysis. Moreover, this operation can be applied when using an SOFC type high-temperature solid oxide fuel cell.

To carry out water electrolysis, it is advantageous to do so at high temperature, typically between 600 and 1000° C., because it is more advantageous to electrolyse steam than liquid water and because part of the energy required for the reaction can be provided by heat, which is cheaper than electricity.

To carry out high-temperature steam electrolysis (HTSE), an SOEC type high-temperature solid oxide electrolyser consists of a stack of elementary units each including a solid oxide electrolysis cell, or an electrochemical cell, made up of three superimposed anode/electrolyte/cathode layers, and interconnection plates, often made of metal alloys, also known as bipolar plates or interconnectors. Each electrochemical cell is sandwiched between two interconnection plates. An SOEC type high-temperature solid oxide electrolyser is thus an alternating stack of electrochemical cells and interconnectors. An SOFC type high-temperature solid oxide fuel cell consists of the same type of stack of elementary units. As this high-temperature technology is reversible, the same stack can function in electrolysis mode and produce hydrogen and oxygen from water and electricity, or in fuel cell mode and produce electricity from hydrogen and oxygen.

Each electrochemical cell corresponds to an electrolyte/electrode assembly, which is typically a multilayer ceramic assembly, the electrolyte of which is formed by a central ion-conducting layer, this layer being solid, dense and sealed, and sandwiched between the two porous layers forming the electrodes. It should be noted that additional layers may exist, but which only serve to improve one or more of the aforementioned layers.

The electrical and fluidic interconnection devices are electronic conductors which provide, from an electrical point of view, the connection of each elementary unit electrochemical cell in the stack of elementary units, guaranteeing electrical contact between one face and the cathode of one cell and between the other face and the anode of the next cell, and from a fluidic point of view, the supply of reagents and the removal of products for each of the cells. The interconnectors thus perform the functions of supplying and collecting electric current and delimit gas flow compartments for distribution and/or collection.

More specifically, the main function of the interconnectors is to ensure the passage of the electric current and also the flow of gases in the vicinity of each cell (i.e. injected steam, hydrogen and oxygen extracted for HTE electrolysis; air and fuel, including injected hydrogen and extracted steam for an SOFC), and to separate the anode and cathode compartments of two adjacent cells, which are the gas flow compartments on the anode and cathode sides of the cells respectively.

In particular, for an SOEC type high-temperature solid oxide electrolyser, the cathode compartment contains steam and hydrogen, the product of the electrochemical reaction, while the anode compartment contains a draining gas, if present, and oxygen, another product of the electrochemical reaction. For an SOFC type high-temperature solid oxide fuel cell, the anode compartment contains the fuel, while the cathode compartment contains the oxidant.

To carry out high-temperature steam electrolysis (HTSE), steam (H₂O) is injected into the cathode compartment. Under the effect of the electric current applied to the cell, water molecules in vapour form are dissociated at the interface between the hydrogen electrode (cathode) and the electrolyte: this dissociation produces hydrogen gas (H₂) and oxygen ions (O²⁻). The hydrogen (H₂) is collected and discharged from the hydrogen compartment. The oxygen ions (O²⁻) migrate through the electrolyte and recombine into oxygen (O₂) at the interface between the electrolyte and the oxygen electrode (anode). A draining gas, such as air, can flow past the anode and thus collect the oxygen generated in gaseous form at the anode.

To use a solid oxide fuel cell (SOFC), air (oxygen) is injected into the cathode compartment of the cell and hydrogen into the anode compartment. The oxygen in the air will dissociate into O²⁻ ions. These ions will migrate in the electrolyte from the cathode to the anode to oxidise the hydrogen and form water, simultaneously producing electricity. In the SOFC, just as with SOEC electrolysis, the steam is in the hydrogen (H₂) compartment. Only the polarity is reversed.

By way of example, FIG. 1 is a schematic view showing the operating principle of an SOEC type high-temperature solid oxide electrolyser. The function of such an electrolyser is to convert steam into hydrogen and oxygen according to the following electrochemical reaction:

2 H₂O→2 H₂+O₂.

This reaction is carried out electrochemically in the cells of the electrolyser.

As shown schematically in FIG. 1, each elementary electrolysis cell 1 consists of a cathode 2 and an anode 4, placed either side of a solid electrolyte 3. The two electrodes (cathode and anode) 2 and 4 are electronic and/or ionic conductors made of porous material, and the electrolyte 3 is gas-tight, electronically insulating and ionically conductive. The electrolyte 3 can in particular be an anionic conductor, more specifically an anionic conductor of O²⁻ ions, and the electrolyser is then referred to as an anionic electrolyser, as opposed to proton (H+) electrolytes.

The electrochemical reactions take place at the interface between each of the electronic conductors and the ionic conductor.

2 H₂O→4 e−→2 H₂+2O²⁻.

At the cathode 2, the half-reaction is the following:

2 O²⁻→O₂+4 e⁻.

The electrolyte 3, interposed between the two electrodes 2 and 4, is where the O²⁻ ions migrate under the effect of the electric field created by the potential difference imposed between the anode 4 and the cathode 2.

As shown in brackets in FIG. 1, the steam at the cathode inlet can be accompanied by hydrogen H₂ and the hydrogen produced and recovered at the outlet can be accompanied by steam. Similarly, as shown by dashed lines, a draining gas, such as air, can also be injected at the inlet on the anode side to remove the oxygen produced. Injecting a draining gas has an additional function of assuming the role of thermal regulator.

An elementary electrolyser or electrolysis reactor consists of an elementary cell as described above, with a cathode 2, an electrolyte 3, and an anode 4, and two interconnectors that perform the functions of electrical and fluidic distribution.

In order to increase the flow of hydrogen and oxygen produced, it is known to stack several elementary electrolysis cells on top of one another, separating them with interconnectors. The assembly is positioned between two end interconnection plates which support the electrical supply and gas supply to the electrolyser (electrolysis reactor).

An SOEC type high-temperature solid oxide electrolyser thus comprises at least one, generally a plurality of electrolysis cells stacked one on top of the other, each elementary cell consisting of an electrolyte, a cathode and an anode, the electrolyte being interposed between the anode and the cathode.

As mentioned above, the fluidic and electrical interconnection devices which are in electrical contact with one or more electrodes generally perform the functions of supplying and collecting electric current and delimit one or more gas flow compartments.

The function of the cathode compartment is thus to distribute the electric current and steam, and to recover hydrogen from the contacted cathode.

The function of the anode compartment is to distribute the electric current, and to recover oxygen produced at the contacted anode, possibly using a draining gas.

FIG. 2 shows an exploded view of elementary units of an SOEC type high-temperature solid oxide electrolyser according to the prior art. This electrolyser includes a plurality of elementary electrolysis cells C1, C2, of solid oxide cell (SOEC) type, stacked alternately with interconnectors 5. Each cell C1, C2 consists of a cathode 2.1, 2.2 and an anode (only the anode 4.2 of the cell C2 is shown), between which an electrolyte is arranged (only the electrolyte 3.2 of the cell C2 is shown).

The interconnector 5 is typically a metal alloy component which provides the separation between the cathode 50 and anode 51 compartments, defined by the volumes comprised between the interconnector 5 and the adjacent cathode 2.1 and between the interconnector 5 and the adjacent anode 4.2 respectively. It also ensures that gases are distributed to the cells. Steam is injected into each elementary unit in the cathode compartment 50. The hydrogen produced and the residual steam at the cathode 2.1, 2.2 are collected in the cathode compartment 50 downstream of the cell C1, C2 after dissociation of the steam by the latter. The oxygen produced at the anode 4.2 is collected in the anode compartment 51 downstream of the cell C1, C2 after disassociation of the steam by the latter. The interconnector 5 ensures that the current passes between the cells C1 and C2 by direct contact with the adjacent electrodes, i.e. between the anode 4.2 and the cathode 2.1.

As the operating conditions of a high-temperature solid oxide electrolyser (SOEC) are very similar to those of a solid oxide fuel cell (SOFC), the same technological constraints apply.

Thus, smooth operation of such stacks of SOEC/SOFC type solid oxide cells operating at high temperature primarily requires compliance with the points set out below.

First of all, electrical insulation is required between two successive interconnectors to avoid short-circuiting the electrochemical cell, as well as good electrical contact and an adequate contact surface between a cell and an interconnector. The lowest possible ohmic resistance is sought between cells and interconnectors.

Furthermore, the anode and cathode compartments must be sealed from one another to avoid recombining the gases produced, leading to a drop in efficiency and in particular the appearance of hot points that damage the stack.

Finally, it is vital to have good gas distribution both at the inlet and at the product recovery stage to avoid a loss of yield, pressure and temperature variations within the various elementary units, and even irreparable damage to the electrochemical cells.

To increase production efficiency and achieve a good level of operating consistency of the stacks of SOEC/SOFC type solid oxide cells operating at high temperature, the role of the interconnectors is vital, in particular to obtain good electrical contact between the various parts of the stacks and also enable the proper distribution of the gases within the electrochemical cells. The interconnectors can be metallic and composed of three thin plates, as described in the French patent application FR 3 024 985 A1.

FIG. 3 thus shows, in an exploded view, an exemplary interconnector 5 according to the prior art formed by the assembly of three thin metal sheets 21 to 23 assembled and laminated.

The three sheets 21, 22, 23 extend along two axes of symmetry X and Y orthogonal to each other, the sheets being laminated and assembled by welding. A central sheet 22 is interposed between a first end sheet 21 and a second end sheet 23.

The central sheet 22 includes an embossed central part 70 defining raised or embossed elements 10, and is pierced at the periphery of its central part 70 by four holes 71, 72, 73, 74. The term “hole” refers to a hole that opens out on either side of a metal sheet.

One of the flat end sheets 21 includes a flat central part 69 and is pierced, at the periphery of its central part 69, by four holes 61, 62, 63, 64. The first end sheet 21 also includes two slots 67, 68, holes arranged symmetrically on either side of the Y axis. They extend over a length substantially corresponding to the length of the central part 69 along the Y axis.

The other of the flat end sheets 23 includes a hollowed-out central part 89 and is pierced, at the periphery of its central part 89, by four holes 81, 82, 83, 84.

The holes 61, 71, 81, 63, 73, 83 of each sheet extend over a length substantially corresponding to the length of the central part 69, 70, 89 along the X axis, while the holes 62, 72, 82, 64, 74, 84 of each sheet extend over a length substantially corresponding to the length of the central part 69, 70, 89 along the Y axis.

The holes 71 to 74 of the central sheet 22 are enlarged respectively in relation to the holes 61, 81, 62, 82, 63, 83, 64, 84, and they have in their enlarged part sheet tabs 710, 720, 730, 740 spaced apart to form a comb. Each of the slots 711, defined between the edge of the enlarged hole 71 and a tab 710 or between two successive tabs 710, opens onto the channels 11 defined by the raised or embossed parts 10. The same applies to the slots on the side of the holes 72, 73, 74.

The sheets 21, 22, 23 are typically made of ferritic steel with around 20% chromium, preferably CROFER® 22APU or FT18TNb, with a nickel base of the Inconel® 600 or Haynes® type in thicknesses typically comprised between 0.1 and 1 mm.

These interconnectors can also be as described in the French patent application FR 2 996 065 A1. In this application, the interconnector corresponds to a component with a metal alloy substrate, the basic element of which is iron (Fe) or nickel (Ni), with one of the main flat faces coated with a thick layer of metal or ceramic, grooved to delimit channels suitable for distributing and/or collecting gases, such as steam H₂O, H₂; O₂, draining gas. In particular, a thick ceramic contact layer containing strontium-doped lanthanum manganite can be provided on the oxygen electrode side (anode in HTE, cathode for an SOFC). “Thick layer” is understood to mean a layer, the thickness of which is greater than that of a layer obtained by so-called “thin film” technology, typically a layer comprised between 2 and 15 μm. A good level of performance is thus achieved with a good level of consistency in the stacks of SOFC/SOEC type solid oxide cells at low production costs.

Nevertheless, there is still a need to optimise such interconnectors, in particular from a fluidic and mechanical point of view, and in particular to reduce the pressure losses that occur during gas flow.

### DISCLOSURE OF THE INVENTION

The object of the invention is to at least partly address the aforementioned needs and overcome the drawbacks of the prior art.

It aims in particular to produce an optimised design of an interconnector for stacks of SOEC/SOFC type solid oxide cells, in particular by modifying the comb tabs and possibly by specific machining of a contact layer of the interconnector, making it possible to obtain, for a given clamping, high electrical conductivity of the interconnector and good mechanical and electrical contact, while reducing the pressure losses for the gas flow.

One object of the invention is thus, according to one of its aspects, an interconnector for a stack of SOEC/SOFC type solid oxide cells operating at high temperature, intended to be arranged between two adjacent electrochemical cells in the stack, each electrochemical cell consisting of a cathode, an anode and an electrolyte interposed between the cathode and the anode, the interconnector being formed by the assembly of at least three plates extending along a first axis of symmetry and a second axis of symmetry orthogonal to each other, a central plate being interposed between a first end plate and a second end plate, the central plate including a central part and, at its periphery, at least two holes extending over a length substantially corresponding to the length of the central part along the first axis of symmetry and two holes extending over a length substantially corresponding to the length of the central part along the second axis of symmetry, each hole including tabs spaced apart to form a comb and slots defined between the edge of a hole and a tab or between two successive tabs, characterised in that the width of each tab of at least one hole is comprised between 0.1 mm and 3 mm, in particular around 1 mm.

The interconnector according to the invention can also have one or more of the following characteristics, either individually or in any feasible technical combination.

The width of each slot of at least one hole can be comprised between 3 and 5 mm, in particular around 4.9 mm.

Moreover, the height of each tab of at least one hole can be comprised between 0.25 and 1 mm, in particular around 0.3 mm.

Furthermore, according to one aspect of the invention, the interconnector, in particular the central part of the central plate, can have a flat face on which at least one first group of first identical elements raised in relation to the flat face and one second group of second identical elements raised in relation to the flat face are formed,
the first raised elements having different geometric characteristics from the second raised elements,
the height of each first raised element, measured as the greatest vertical dimension of the first raised element in relation to the flat face, being different from the height of each second raised element, measured as the greatest vertical dimension of the second raised element,
the contact width of each first raised element, measured as the greatest horizontal dimension in relation to the flat face of the outer contact end of each first raised element, opposite the inner end in contact with the flat face and intended to be in contact with an electrochemical cell, being different from the contact width of each second raised element, measured as the greatest horizontal dimension in relation to the flat face of the outer contact end of each second raised element, opposite the inner end in contact with the flat face and intended to be in contact with an electrochemical cell.

In addition, the first raised elements can have a contact width larger than the contact width of the second raised elements, and the first raised elements can be located in line with the tabs of at least one hole and the second raised elements can be located in line with the slots of said at least one hole.

Moreover, the contact width of the first raised elements can advantageously be equal to the width of the tabs of said at least one hole.

The contact width of each first raised element can be comprised between 0.5 and 5 mm, preferably equal to 1 mm.

The contact width of each second raised element can be comprised between 0.005 mm and 0.5 mm, preferably equal to 100 μm.

The height of each first raised element can be comprised between 200 μm and 1000 μm, preferably equal to 350 μm.

The height of each second raised element can be comprised between 250um and 1050 μm, preferably equal to 400 μm.

The difference between the height of each second raised element and the height of each first raised element can be comprised between 5 μm and 500 μm, preferably around 50 μm.

Furthermore, the interconnector can include a number N, N being an integer greater than or equal to 2, preferably comprised between 2 and 50, more preferably still equal to 5, of groups of raised elements, formed on the flat face, the raised elements of a same group all being identical, and the raised elements of different groups having different geometric characteristics, namely different heights and different contact widths.

The raised elements can be in the form of teeth or grooves, arranged parallel to one another, the spaces between the raised elements forming gas flow channels.

The raised elements can also be in the form of studs, in particular cylindrical ones, the spaces between the raised elements forming a single serpentine gas flow channel. Other shapes are also possible, for example a parallelepiped shape.

In addition, the raised elements can be evenly distributed over the flat face, being in particular spaced apart by a same distance, in particular comprised between 50 μm and 5 mm, preferably equal to 750 μm, along at least one horizontal direction on the flat face.

At least one area of the flat face, in particular a central area, may not include any raised elements.

Moreover, the raised elements having the greatest width can be located at the periphery of the flat face, at a distance from the other raised elements and from the gas flow channel or channels formed by the spaces between the other raised elements.

The interconnector can include a metal alloy substrate, in particular of the chromium-forming type, the basic element of which is iron or nickel, in particular ferritic steels of the Uginox® K41 type or the VDM® Crofer type, having two main flat faces, one of the main flat faces comprising a first coating layer forming a first contact layer with an electrochemical cell, the other of the main flat faces comprising a second coating layer forming a second contact layer with an electrochemical cell, the first coating layer and/or the second coating layer comprising a flat face and raised elements formed thereon, in particular by machining.

The first coating layer can be a thick ceramic coating layer, which is porous or not, the ceramic material being chosen in particular from lanthanum manganite of formula La₁₋ₓSrₓMO₃ with M (transition metals)=nickel (Ni), iron (Fe), cobalt (Co), manganese (Mn), chromium (Cr), alone or as a mixture, or materials with a lamellar structure such as lanthanide nickelates of formula Ln₂NiO₄ (Ln=lanthanum (La), neodymium (Nd), praseodymium (Pr)), or another electrically conductive perovskite oxide.

The second coating layer can be a thick metal coating layer, in particular of the grid or dense material type, the metallic material being chosen in particular from nickel (Ni) and its alloys or chromium-forming alloys, the basic element of which is iron (Fe), in particular ferritic steels of the Uginox® K41 type or the VDM® Crofer type.

Furthermore, another object of the invention, according to another of its aspects, is a stack of SOEC/SOFC type solid oxide cells operating at high temperature, including a plurality of electrochemical cells each consisting of a cathode, an anode and an electrolyte interposed between the cathode and the anode, and a plurality of interconnectors as defined above, each arranged between two adjacent electrochemical cells.

### BRIEF DESCRIPTION OF THE DRAWINGS

The invention will be better understood upon reading the detailed description below of non-limiting exemplary embodiments thereof, as well as upon viewing the schematic and partial figures of the appended drawing, in which:

FIG. 1 is a schematic view showing the operating principle of a high-temperature solid oxide electrolyser (SOEC),

FIG. 2 is an exploded schematic view of part of a high-temperature solid oxide electrolyser (SOEC) comprising interconnectors according to the prior art,

FIG. 3 is an exploded view of an interconnector for a stack of high-temperature SOEC/SOFC type solid oxide cells, corresponding to the assembly of three thin sheets or plates,

FIG. 4 is a partial cross-sectional view of an interconnector 5 according to the prior art made up of three thin sheets or plates, the central sheet including tabs,

FIG. 5 is a schematic front view of an interconnector according to the prior art of a high temperature electrolysis (SOEC) or fuel cell (SOFC) stack operating at high temperature,

FIG. 5A is a cross-sectional detail view of an interconnector according to FIG. 5,

FIG. 5B is a view similar to FIG. 5 showing the current lines running through the interconnector,

FIG. 6 shows, in a partial perspective view, an exemplary interconnector according to the invention comprising tabs with optimised geometry and raised elements,

FIG. 7 is a graph showing the height, expressed in mm, of the teeth of an interconnector as a function of the length, expressed in mm, for a pre-clamping design and a post-clamping design of a high-temperature electrolysis (SOEC) or high-temperature fuel cell (SOFC) stack,

FIG. 8 is a graph showing the polarization curves for three different designs with two different tooth geometries and two different clamping forces,

FIG. 9 is a cross-sectional view of two teeth and of a channel of a conventional interconnector of a stack of high-temperature SOEC/SOFC type solid oxide cells,

FIG. 10 is a cross-sectional view of five teeth and of four channels of an interconnector for a stack of high-temperature SOEC/SOFC type solid oxide cells, before clamping,

FIG. 11 is a cross-sectional view of the design of FIG. 9, after clamping,

FIG. 12 is a top view of the design of FIG. 10 and FIG. 11,

FIG. 13 is a partial perspective view of an interconnector according to the invention comprising tabs with optimised geometry and an optimised position in relation to the raised elements,

FIG. 14 is an alternative embodiment of the design of FIG. 10,

FIG. 15 is a top view of the design of FIG. 14,

FIG. 16 is an alternative embodiment of the design of FIG. 15,

FIG. 17 is an alternative geometric embodiment of the design of FIG. 10,

FIG. 18 is an alternative embodiment of the design of FIG. 17, and

FIG. 19 shows, in perspective and viewed from above, an assembly comprising a stack of SOEC/SOFC type solid oxide cells with interconnectors according to the invention and a system for clamping the stack.

Throughout these figures, identical reference numerals are used to designate identical or similar elements.

Moreover, the various parts shown in the figures are not necessarily shown on a uniform scale, to make the figures easier to read.

### DETAILED DESCRIPTION OF PARTICULAR EMBODIMENTS

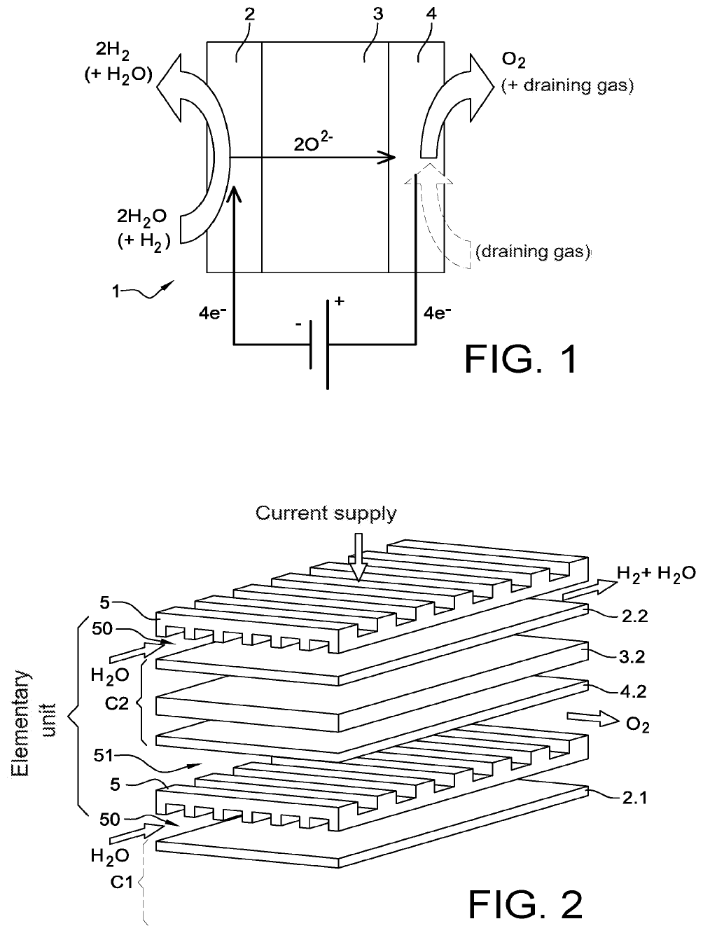

FIGS. 1 to 3 have already been described above in the section relating to the prior art and the technical context of the invention. It should be noted that, in FIGS. 1 and 2, the symbols and arrows for the supply of steam H₂O, the distribution and recovery of hydrogen H₂, oxygen O₂, air and electric current, are shown for clarity and precision, to illustrate the operation of the devices shown.

In addition, it should be noted that all the components (anode/electrolyte/cathode) of a given electrochemical cell are preferably ceramic. The operating temperature of a high-temperature SOEC/SOFC type stack is typically comprised between 600 and 1000° C.

Furthermore, the terms “upper” and “lower” are to be understood here as referring to the normal direction of orientation of an SOEC/SOFC type stack in its use configuration.

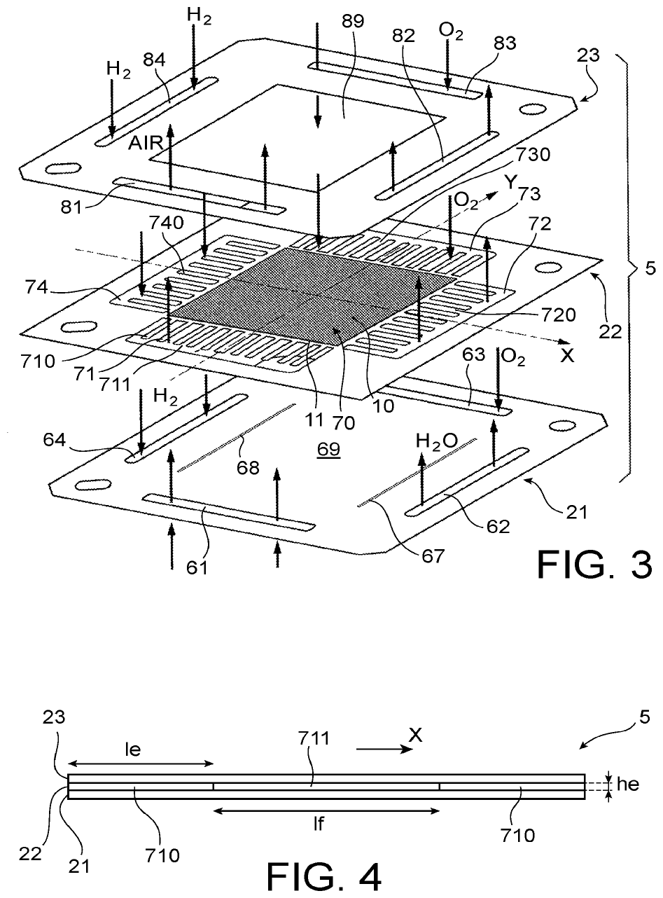

An interconnector 5 according to the prior art has already been described above with reference to FIG. 3. Similar elements will not be described again but remain within the scope of the invention.

FIG. 4 is a partial cross-sectional view of such an interconnector 5 comprising the three sheets 21, 22 and 23, the cross-section being taken partially at the tabs 710 and slots 711 of the hole 71 in order to display the dimensions of these. Of course, these are similar for the holes 72, 73, 74.

In this way, in a standard configuration, the width le, measured along the axis X, of a tab 710 is around 4 mm. Moreover, the width If of a slot 711, measured along the axis X, is around 6.4 mm. The height he of each tab 710, measured perpendicular to the axis X, is around 0.2 mm. Furthermore, the total width of the hole 71 is around 100 mm, but it could be greater.

For an air flow of around 12 Nl/min/cell/cm², the pressure loss due to the tabs 710 is around 50 mbar. In this configuration, the pressure loss arises from the limited flow volume and also from the tendency for the channels 11 to be compressed. This compression occurs when the plate 23, or sheet, deforms and gets closer to the central plate 22.

In order to optimise the geometry of the tabs 710 and slots 711, according to the invention, the width le of the tabs 710 is comprised between 0.1 mm and 3 mm. In this way, the width le of each tab 710 is reduced to create a larger volume of channels 11. The width le of the tabs 710 is preferably around 1 mm, which strikes an optimum balance between difficulty of design and gain in gas flow volume.

In addition, according to the invention, the width If of each slot 711 is comprised between 3 and 5 mm, with a value of preferably around 4.9 mm, which is an optimum for reduced compression without having to reduce the volume of the gas channels 11 too much.

Furthermore, according to the invention, the height he of each tab 710 is increased using a central sheet 22 with a greater height than the standard height of 0.2 mm. In this way, the height he of each tab 710 is comprised between 0.25 and 1 mm, with a value of preferably 0.3 mm, which is an optimum that greatly reduces pressure losses whilst increasing the volume of the channels 11 for the flow of gas and limiting the quantity of metal to be used as well as the overall height of the interconnector 5.

These modifications according to the invention can therefore reduce pressure losses by at least 25% and up to around 80%.

Furthermore, an interconnector 5 can have a specific geometry, in particular grooved with the presence of teeth and channels. For example, as described in the French patent application FR 2 996 065 A1, the interconnector 5 can consist of a component including a metal alloy substrate, in particular of the chromium-forming type, the basic element of which is iron or nickel, in particular ferritic steels of the Uginox® K41 type or the VDM® Crofer type, this substrate having two main flat faces, one of the faces being coated with a coating including a thick ceramic layer, which is porous or not, grooved to delimit channels for distributing and/or collecting gases and teeth, this layer also being referred to as the “contact layer”. In this way, the teeth and channels can be formed on the contact layer. In addition, in the description below, it is understood that the teeth and channels, or more generally the raised parts, of an interconnector 5 can be formed on a contact layer of this interconnector 5.

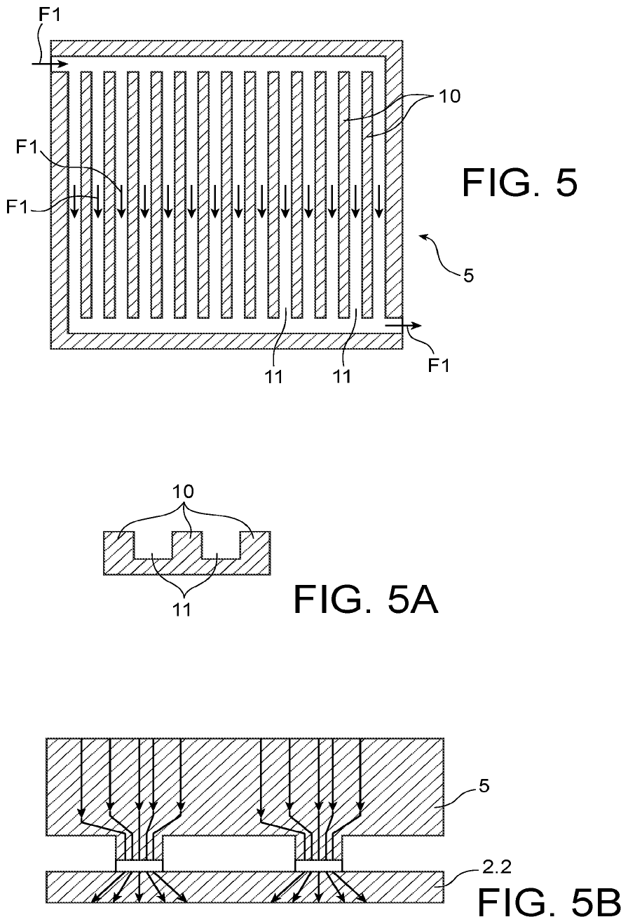

FIGS. 5, 5A and 5B show an interconnector 5 widely used in a high-temperature SOEC/SOFC type stack. The current is supplied or collected at the electrode by the raised elements in the form of teeth 10, or ribs, which are in direct mechanical contact with the electrode in question. The supply of steam to the cathode or draining gas to the anode in an HTE electrolyser, and the supply of oxygen to the cathode or hydrogen to the anode in an SOFC is shown by the arrows F1 in FIG. 5.

The hydrogen produced at the cathode or the oxygen produced at the anode in an HTE electrolyser, and the water produced at the cathode or the surplus hydrogen at the anode in an SOFC is collected by the channels 11 which open into a fluid connection, commonly called a manifold, shared by the stack of cells. The structure of these interconnectors 5 is designed to strike a balance between the two functions of supply and collection (gas/current).

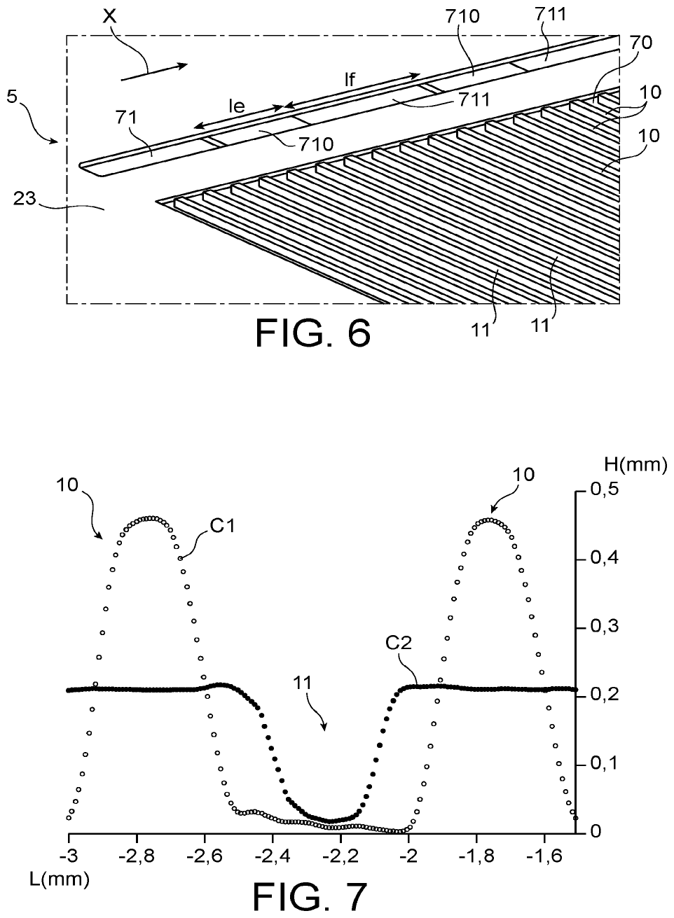

Furthermore, FIG. 6 is a partial perspective view of the teeth 10 and channels 11, also showing the tabs 710 and slots 711. According to the invention, the width le of the tabs 710 is comprised between 0.1 mm and 3 mm, preferably around 1 mm. Moreover, the width If of each slot 711 is comprised between 3 and 5 mm, with a value of preferably around 4.9 mm. Likewise, the height he of each tab 710 is comprised between 0.25 and 1 mm, with a value of preferably 0.3 mm.

In order to achieve good electrical conductivity between an interconnector 5, in particular the contact layer, and an electrochemical cell, the teeth 10 must be spaced close together. However, this tends to result in a reduced gas flow area, which can lead to significant pressure losses during operation.

Furthermore, the interconnector 5 must allow the gases to flow correctly and have low pressure losses, which can be achieved using wide channels 11. However, this leads to teeth 10 being spaced apart, which reduces electrical conductivity.

In addition, the geometry of the teeth 10 and channels 11 must be able to accommodate surface defects, particularly of the cells and interconnector 5. For this, they must be easily collapsible. This can, for example, be achieved by designing teeth 10 having a small width. However, if the teeth 10 are compressed a lot, the height of the channels 11 will decrease a lot and the gas flow area will be reduced, which will lead to higher pressure losses. By way of example, FIG. 7 is a graph showing the height H, expressed in mm, of the teeth 10 as a function of the length L, expressed in mm, for a pre-clamping design C1 and a post-clamping design C2.

The force applied to a stack of SOEC/SOFC type solid oxide cells is used to calculate the local clamping stress. For example, if a force F of 1000 N is applied and the bearing surface S is 100 cm², then the stress F/S will be 0.2 MPa. If contact is made using the teeth 10 of an interconnector 5, in particular its contact layer, which represent half the surface area, then the local stress will be 0.4 MPa.

Three real experiments (E1, E2, E3) to produce hydrogen from an SOEC type stack of five cells with a surface area of 100 cm² were carried out with two different interconnector geometries (tooth A and tooth B) and two different clamping forces (force A and force B). A total flow rate of 12 Nml/min/cell/cm² of steam/hydrogen mixture was delivered. The H₂O/H₂ mixture is 90% H₂O and 10% H₂. The temperature of the stack is 800° C.

A polarization curve (E1 for tooth A, force A; E2 for tooth B, force A; E3 for tooth B, force B) is made each time by progressively increasing the current i, expressed in A/cm², and measuring the voltage E, expressed in V, of associated cells. These curves are used to measure the maximum rate of use t of steam, as well as the area specific resistance (ASR) from cells, interconnectors, interfaces, connection systems, etc.

The interconnector reference geometry includes an interconnector, in particular a contact layer, with teeth 10 with a width A (tooth A). A second interconnector geometry was produced with teeth 10 with a width B (tooth B), three times less than the width A. The applied force can be the reference force A (force A) or the force B, three times less than the force A.

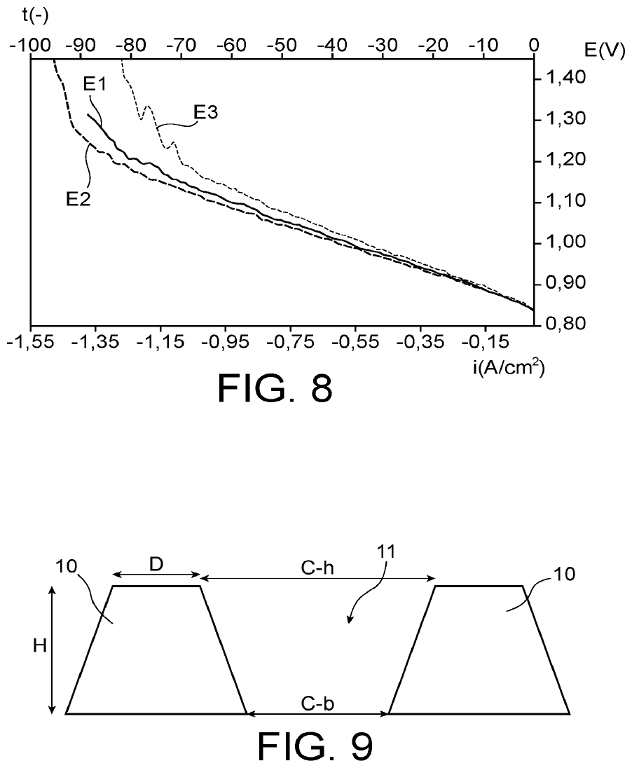

FIG. 8 is a graph showing the polarization curves E1, E2, E3 obtained for three stacks with two different interconnector geometries (tooth A, tooth B) and two different forces (force A, force B). Moreover, Table 1 below shows the relative pressure losses obtained from the O₂ chamber.

TABLE 1
pressure losses

| | Tooth A | Tooth B |
|---|---|---|
| Force A | 100 | 180 |
| Force B | | 60 |

Thus, when the teeth are thinner (tooth B) while maintaining the same clamping force (force A), the ASR is lower, so performance is improved, but pressure losses are increased. The crushing of the teeth has reduced the gas flow area. When the teeth are thinner (tooth B) but there is a reduced force (force B), performance is impaired (higher ASR and reduced maximum use rate) but the pressure losses are significantly reduced.

One particular aspect of the invention, which provides for a specific geometry of the raised elements 10, in particular the teeth, in addition to the optimised geometry of the tabs 711, and which will now be described with reference to FIGS. 9 to 18, thus aims to optimise these aspects, and in particular to obtain an interconnector design, in particular of the contact layer, making it possible both to have good compression of the teeth 10 and to maintain gas flow channels 11 with a large volume.

An interconnector 5 of a stack of SOEC/SOFC type solid oxide cells operating at high temperature, intended to be arranged between two adjacent electrochemical cells 1 in the stack, each cell consisting of a cathode, an anode and an electrolyte interposed between the cathode and the anode, usually has a regular geometry. In particular, the contact layer forming a coating on one of the faces of a metal alloy substrate of the interconnector 5 conventionally includes teeth 10 and channels 11 with a regular geometry. In this way, the teeth 10 all have the same dimensions (height and width) and all the channels 11 have the same width. The main features of the teeth 10 and channels 11 are detailed in the cross-sectional view of FIG. 9. In this way, the contact width of a tooth 10 is marked D, the width of the top of the channel 11 is marked C-h whilst the width of the bottom of the channel 11 is marked C-b, and the height of the teeth 10 is marked H.

According to one aspect of the invention, the geometry of the interconnector 5, in particular the contact layer, is modified to obtain an irregularity that provides both optimum electrical contact and a gas distribution that offers little resistance to the flow of gases, and therefore little excess pressure. In particular, irregular machining is carried out to obtain teeth and channels with different characteristics on the same interconnector 5, in particular on the same contact layer of this interconnector 5.

In this way, the interconnector 5 includes a flat face P on which at least one first group of first identical raised elements 10a and one second group of second identical raised elements 10b are formed, the first 10a and second 10b raised elements having different geometric characteristics.

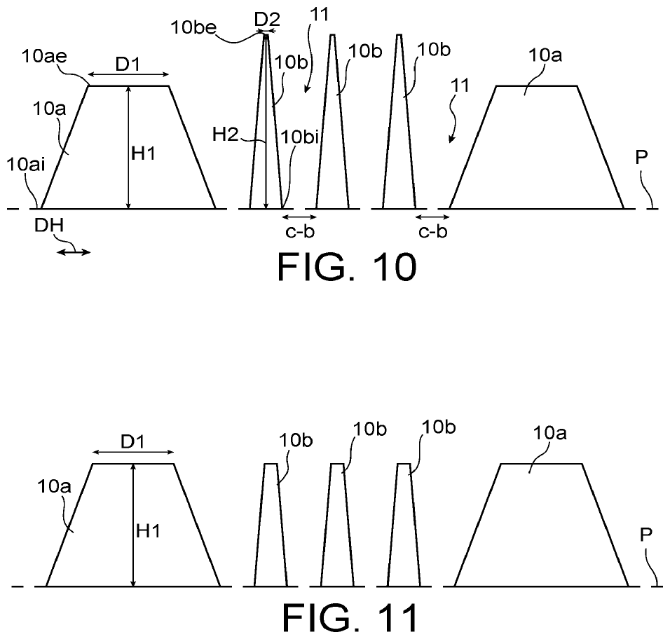

FIGS. 10 and 11 show, before and after compression, an exemplary embodiment with two types of machining geometry. However, a plurality of different geometries can be provided for the interconnector 5 within the scope of the invention.

In this way, the height H1 of each first raised element 10a, measured as the greatest vertical dimension of the first raised element 10a in relation to the flat face P, is different from the height H2 of each second raised element 10b, measured as the greatest vertical dimension of the second raised element 10b. Similarly, the contact width D1 of each first raised element 10a, measured as the greatest horizontal dimension in relation to the flat face P of the outer contact end 10ae of each first raised element 10a, opposite the inner end 10ai in contact with the flat face P and intended to be in contact with an electrochemical cell 1, is different from the contact width D2 of each second raised element 10b, measured as the greatest horizontal dimension in relation to the flat face P of the outer contact end 10be of each second raised element 10b, opposite the inner end 10bi in contact with the flat face P and intended to be in contact with an electrochemical cell 1.

In particular, the contact width D1 of each first raised element 10a is comprised between 0.5 and 5 mm, preferably being equal to 1 mm. This large width means it can withstand clamping stresses and act as a compression limiter.

The contact width D2 of each second raised element 10b is comprised between 0.005 mm and 0.5 mm, preferably being equal to 100 μm. This small width means that contact points can be evenly distributed over the entire electrochemical cell 1 contact surface without interfering with fluid flow.

Furthermore, the height H1 of each first raised element 10a is lower than the height H2 of each second raised element 10b, being, for example, 350 and 400 μm respectively. In this way, the raised elements 10b having a small width D2 ensure the electrical contact.

It should be noted that in this example shown in FIGS. 10 and 11, the raised elements 10a, 10b, 10c are in the form of teeth or grooves, arranged parallel to one another. However, the raised elements could take any shape to ensure electrical contact and gas flow. In this way, the spaces between the raised elements 10a, 10b, 10c form gas flow channels 11.

Furthermore, the raised elements 10a, 10b are distributed uniformly here over the flat face P. Specifically, they are spaced apart by the same distance C-b, in particular comprised between 50 μm and 5 mm, and preferably equal to 750 μm, along at least one horizontal direction DH on the flat face P. The spacing between raised elements 10a, 10b is therefore constant and enables an even distribution of the current within the electrode of the electrochemical cell 1. The value of the spacing can depend on the electrochemical cell 1 used.

During clamping, the raised elements 10b will be compressed first because they are higher. The compression will be great because the contact width D2 is small. This will therefore enable geometric defects to be accommodated.

This compression will continue until the height H2 of the raised elements 10b reaches the height H1 of the raised elements 10a. The contact surface will therefore increase rapidly, which will stop the compression. This stop to the compression preserves large spaces for the gas flow channels 11. In this way, the pressure losses can remain low. Moreover, the fact that the spacing C-b between the raised elements 10a, 10b is quite low produces good electrical conductivity.

Advantageously, the invention does not require fine adjustment of the clamping force to stop compression. Indeed, the large increase in surface area when contact is made with the raised elements 10a allows the stress to be significantly reduced, limiting the effect of the initial force.

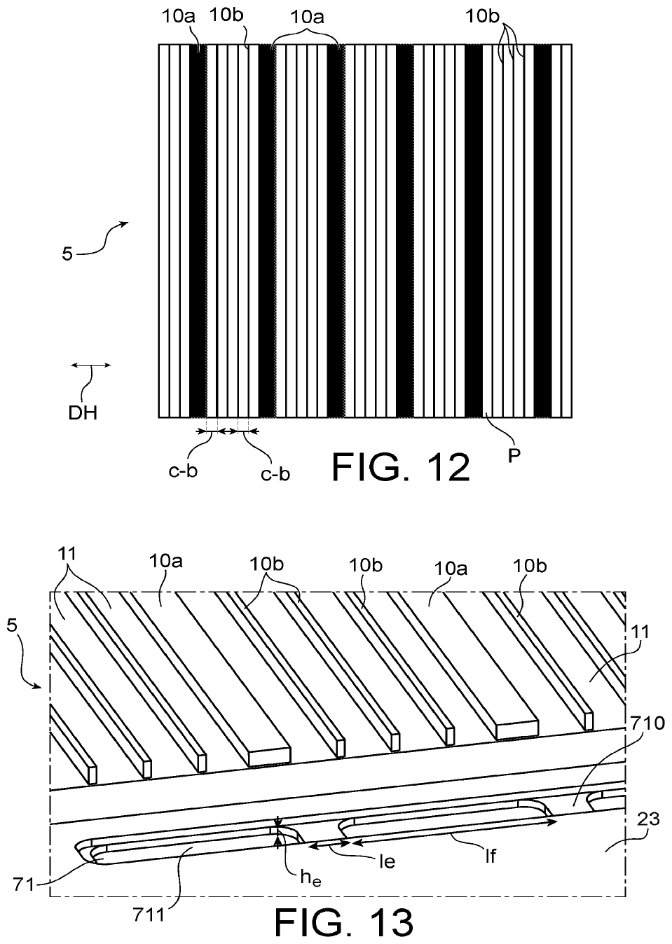

FIG. 12 shows the regular distribution of the first 10a and second 10b raised elements from the example shown in FIGS. 10 and 11.

According to the invention, the position of the tabs 710 is coupled to the teeth 10 of the interconnector 5, as shown in FIG. 13.

In this way, the teeth 10a with width D1 are positioned in line with the tabs 710 whilst the thin teeth 10b with width D2 are located opposite the slots 711. This optimises the fluidics of the interconnector 5, particularly the contact layer.

The width D1 of the teeth 10a is advantageously equal to the width le of the tabs 710.

The width D1 advantageously does not generate any particular excess pressure as it corresponds to the width of the tabs 711. In addition, distribution fluidics are improved because the gas flows in a straight line without flow disturbance.

Furthermore, as the manufacture of the interconnectors 5 and the electrochemical cells 1 is not consistent, it may also be advantageous to have an interconnector 5, in particular a contact layer of the interconnector 5 comprising the raised elements, the compression of which can be modulated during operation. In this way, by creating a number N of different geometries, it is possible to obtain compression stages that are easily accessible, even during a test. In other words, the interconnector can more generally include a number N, N being an integer greater than or equal to 2, preferably comprised between 2 and 50, more preferably still equal to 5, of groups of raised elements, formed on the flat face P, the raised elements of a same group all being identical, and the raised elements of different groups having different geometric characteristics, namely different heights and different contact widths.

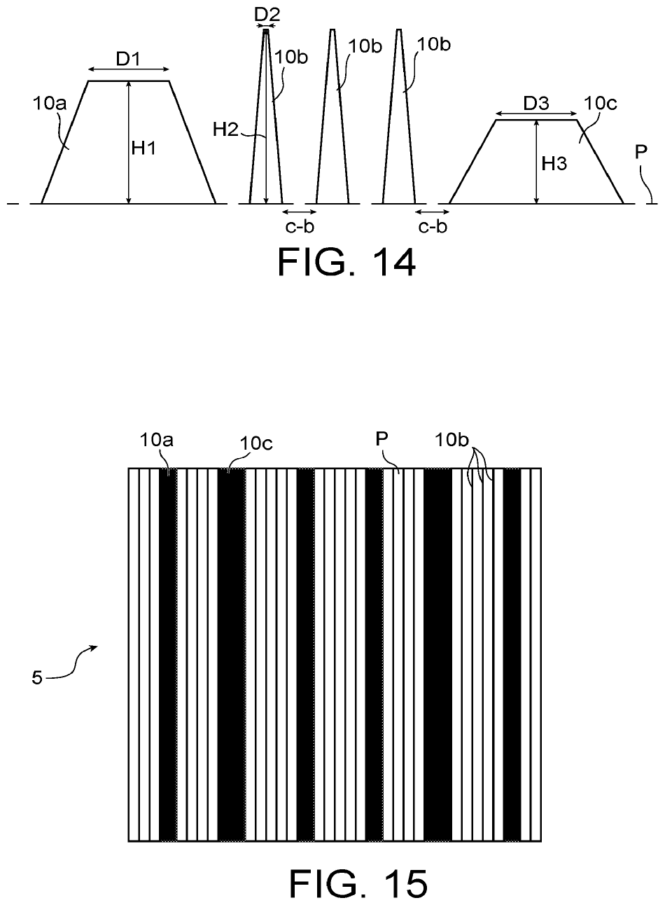

FIGS. 14 and 15 show a case where N=3, which is only an illustrative and non-limiting example of the invention. In this way, the interconnector 5 comprises first raised elements 10a with contact width D1 and height H1, second raised elements 10b with contact width D2 and height H₂, and third raised elements 10c with contact width D3 and height H3. The chosen values are such that D3>D1>D2 et H2>H1>H3.

This enables several possible compression levels. In this way, it is possible to have a compression at a force 1 which will only compress the raised elements 10b. If this is inadequate because the geometric defects to be compensated for are significant, it is possible to move to a force 2, greater than the force 1, to compress the raised elements 10a up to the height H3 of the raised elements 10c. In this way, compression and contact can be adjusted as required.

It is therefore possible, if required, to have N different geometries with an increasing contact width. The continuous increase in clamping force would enable the raised elements to be compressed in stages, then stopped as soon as contact was good and for optimum compression. This produces an interconnector 5, or a contact layer thereof, that is adapted to all geometries.

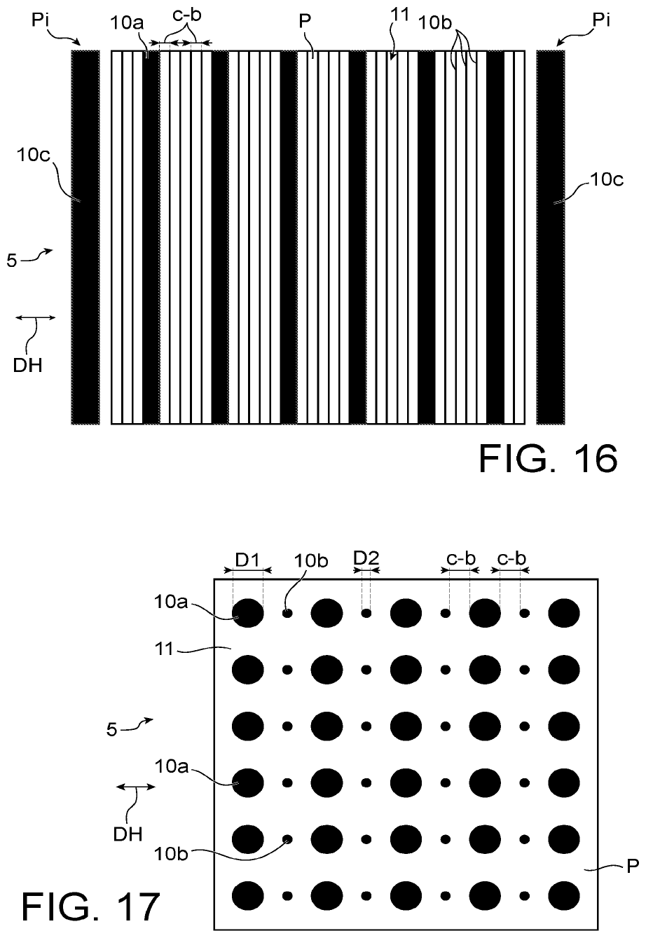

FIG. 16 shows the option of including the raised elements 10c having the greatest contact width D3 being located at the periphery Pi of the flat face P, at a distance from the other raised elements 10a, 10b and from the gas flow channels 11.

These raised elements 10c form the compression limiters as they have the greatest contact width D3. They can be located outside the active zone. In this way, the maximum surface area is reserved for gas flow.

In addition, any shape remains possible for the raised elements 10a, 10b, 10c. They are not necessarily in the form of teeth as described above.

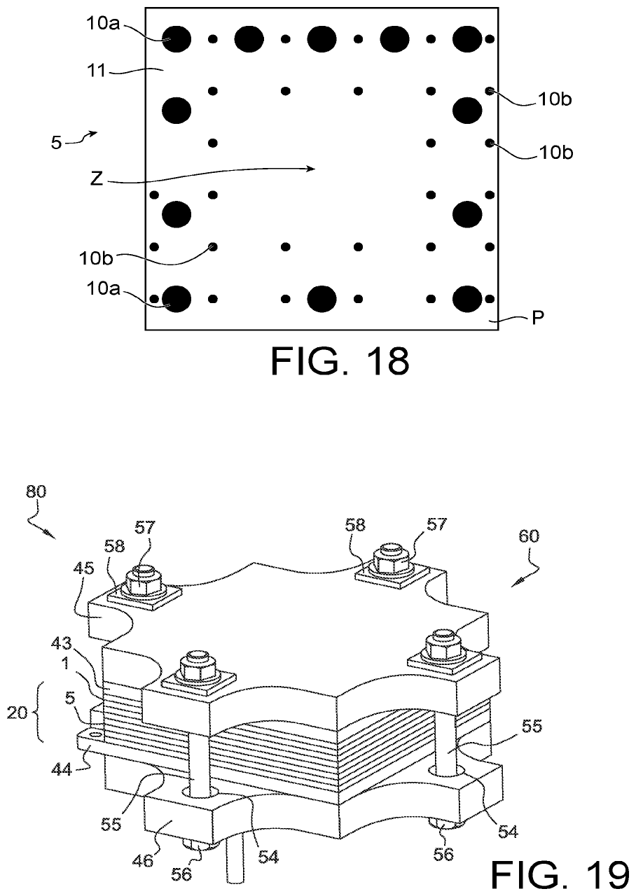

In this way, FIGS. 17 and 18 show the option of having raised elements 10a, 10b in the form of studs, and in particular cylindrical ones. Other shapes are also possible, for example a parallelepiped shape. The spaces between the raised elements 10a, 10b thus form a single serpentine gas flow channel 11.

This can advantageously enable the stresses to be regulated as accurately as possible with a suitable surface and optimised gas flow.

Furthermore, FIG. 18 shows the option of having at least one zone Z of the flat face P, the central zone Z in this case, which does not include any raised elements. Indeed, heat generated by excessively large surface areas of electrochemical cells 1 can lead to problems of overheating, particularly in the centre of the cells 1 where it is difficult to remove the heat. In this way, it is possible to deliberately limit the reactions at the core of the cells 1 by reducing the conductivity in the specific central zone Z, which is thus deliberately deprived of electrical contact.

It should be noted that, advantageously, the interconnector 5 according to the invention can include a metal alloy substrate, in particular of the chromium-forming type, the basic element of which is iron (Fe) or nickel (Ni), in particular ferritic steels of the Uginox® K41 type or the VDM® Crofer type, having two main flat faces, as described in the French patent application FR 2 996 065 A1.

One of the main flat faces comprises a first coating layer forming a first contact layer with an electrochemical cell 1, and the other of the main flat faces comprises a second coating layer forming a second contact layer with an electrochemical cell 1.

The first coating layer and/or the second coating layer can comprise the flat face P and the raised elements 10a, 10b, 10c formed thereon, in particular by machining, as described above.

These raised elements may or may not be identical on the first and second coating layers, and their distribution may or may not be identical on the first and second coating layers, when these two coating layers are provided with such raised elements.

The first coating layer can in particular be a first thick ceramic contact layer, which is porous or not, in particular containing strontium-doped lanthanum manganite. It can be provided on the oxygen electrode side.

The second coating layer can in particular be a second thick metal contact layer, in particular containing nickel. It can be provided on the hydrogen electrode side.

This second layer can in particular include at least two different types of nickel grid. On these grids, the number of meshes per cm2 and the wire diameter can be modulated. It is, for example, possible to use a grid A with height Ha with a number of meshes Na, forming raised elements, allowing it to be greatly compressed, and a second grid B with height Hb, lower than the height Ha, with a number of meshes Nb, forming raised elements, less than the number of meshes Na, so as to assume the role of compression limiter.

Furthermore, FIG. 19 shows a stack 20 of SOEC/SOFC type solid oxide cells operating at high temperature according to the invention.

More specifically, FIG. 19 shows an assembly 80 comprising the stack 20 of SOEC/SOFC type solid oxide cells and a clamping system 60.

This assembly 80 has a similar structure to the one described in the French patent application FR 3 045 215 A1.

The stack 20 includes a plurality of electrochemical cells 1 each consisting of a cathode, an anode and an electrolyte interposed between the cathode and the anode, and a plurality of interconnectors 5 according to the invention, each arranged between two adjacent electrochemical cells 1. This assembly of electrochemical cells 1 and interconnectors 5 can also be referred to as a “stack”.

Moreover, the stack 20 includes an upper end plate 43 and a lower end plate 44, respectively also referred to as upper stack end plate 43 and lower stack end plate 44, between which the plurality of electrochemical cells 1 and the plurality of interconnectors 5 are clamped, i.e. between which the stack is located.

Furthermore, the assembly 80 also includes a system 60 for clamping the stack 20 of SOEC/SOFC type solid oxide cells, including an upper clamping plate 45 and a lower clamping plate 46, between which the stack 20 of SOEC/SOFC type solid oxide cells is clamped.

Each clamping plate 45, 46 of the clamping system 60 includes four clamping holes 54. Moreover, the clamping system 60 also includes four clamping rods 55, or tie rods, extending through a clamping hole 54 in the upper clamping plate 45 and through a corresponding clamping hole 54 in the lower clamping plate 46 to enable the upper clamping plate 45 and the lower clamping plate 46 to be joined together. The clamping system 60 also includes clamping means 56, 57, 58 at each clamping hole 54 of the upper 45 and lower 46 clamping plates cooperating with the clamping rods 55 to enable the upper clamping plate 45 and the lower clamping plate 46 to be joined together. More specifically, the clamping means include, at each clamping hole 54 of the upper clamping plate 45, a first clamping nut 56 cooperating with the corresponding clamping rod 55 inserted through the clamping hole 54. Moreover, the clamping means include, at each clamping hole 54 of the lower clamping plate 46, a second clamping nut 57 associated with a clamping washer 58, these cooperating with the corresponding clamping rod 55 inserted through the clamping hole 54. The clamping washer 58 is located between the second clamping nut 57 and the lower clamping plate 46.

Of course, the invention is not limited to the exemplary embodiments that have just been described. Various modifications can be made to it by a person skilled in the art.

1. An interconnector for a stack of SOEC/SOFC type solid oxide electrochemical cells operating at high temperature, configured to be arranged between two adjacent electrochemical cells in the stack, each electrochemical cell comprising a cathode, an anode and an electrolyte interposed between the cathode and the anode, the interconnector comprising:
an assembly of at least three plates extending along a first axis of symmetry and a second axis of symmetry orthogonal to each other, a central plate being interposed between a first end plate and a second end plate, the central plate including a central part and, at its periphery, at least two holes extending over a length substantially corresponding to a length of the central part along the first axis of symmetry and two holes extending over a length substantially corresponding to a length of the central part along the second axis of symmetry, each hole including tabs spaced apart to form a comb and slots defined between an edge of a hole and a tab or between two successive tabs, wherein
a width of each tab of at least one hole is comprised between 0.1 mm and 3mm, in particular around 1 mm,
the interconnector includes a metal alloy substrate having two main flat faces, one of the main flat faces comprising a first coating layer forming a first contact layer with an electrochemical cell, the other of the main flat faces comprising a second coating layer forming a second contact layer with an electrochemical cell, and
the first coating layer and/or the second coating layer comprises a flat face (P) and raised elements formed thereon.

2. The interconnector according to claim 1, wherein a width of each slot of at least one hole is comprised between 3 and 5 mm.

3. The interconnector according to claim 1, characterised in that the wherein a height of each tab of at least one hole is comprised between 0.25 and 1 mm.

4. The interconnector according to claim 1, wherein
the central part of the central plate, includes a flat face on which at least one first group of first identical elements raised in relation to the flat face and one second group of second identical elements raised in relation to the flat face are formed,
the first raised elements have different geometric characteristics from the second raised elements,
a height of each first raised element, measured as a greatest vertical dimension of the first raised element in relation to the flat face, is different from a height of each second raised element, measured as a greatest vertical dimension of the second raised element, and
a contact width of each first raised element, measured as a greatest horizontal dimension in relation to the flat face of an outer contact end of each first raised element, opposite an inner end in contact with the flat face and configured to be in contact with an electrochemical cell, is different from a contact width of each second raised element, measured as a greatest horizontal dimension in relation to the flat face of an outer contact end of each second raised element, opposite an inner end in contact with the flat face and configured to be in contact with an electrochemical cell.

5. The interconnector according to claim 4, wherein the first raised elements have a contact width larger than the contact width of the second raised elements, the first raised elements being located in line with the tabs of at least one hole and the second raised elements being located in line with the slots of the at least one hole.

6. The interconnector according to claim 5, wherein the contact width of the first raised elements is equal to the width of the tabs of the at least one hole.

7. The interconnector according to claim 4, wherein
the contact width of each first raised element is comprised between 0.5 and 5 mm, and
the contact width of each second raised element is comprised between 0.005 mm and 0.5 mm,
the height of each first raised element is comprised between 200 μm and 1000 μm, and
the height of each second raised element is comprised between 250 μm and 1050 μm.

8. The interconnector according to claim 4, wherein a difference between the height of each second raised element and the height of each first raised element is comprised between 5 μm and 500 μm.

9. The interconnector according to claim 4, comprising a number N, N being an integer greater than or equal to 2, of groups of raised elements, formed on the flat face, the raised elements of a same group all being identical, and the raised elements of different groups having different geometric characteristics.

10. The interconnector according to claim 4, wherein the raised elements are in a form of teeth or grooves, arranged parallel to one another, the spaces between the raised elements forming gas flow channels.

11. The interconnector according to claim 4, wherein the raised elements are in a form of studs, spaces between the raised elements forming a single serpentine gas flow channel

12. The interconnector according to claim 4, wherein the raised elements having the greatest width are located at a periphery of the flat face, at a distance from other raised elements and from gas flow channel or channels formed by the spaces between the other raised elements.

13. The interconnector according to claim 1, wherein
the metal alloy substrate is of a chromium-forming type, a basic element of which is iron (Fe) or nickel (Ni), and
the raised elements formed on the flat face are formed by machining.

14. The interconnector according to claim 1, wherein the first coating layer is a thick ceramic coating layer, a ceramic material of the ceramic coating layer being chosen from lanthanum manganite of formula La₁₋ₓSrₓMO₃ with M (transition metals)=nickel (Ni), iron (Fe), cobalt (Co), manganese (Mn), chromium (Cr), alone or as a mixture, or materials with a lamellar structure including lanthanide nickelates of formula Ln₂NiO₄ (Ln=lanthanum (La), neodymium (Nd), praseodymium (Pr)), or another electrically conductive perovskite oxide.

15. The interconnector according to claim 1, wherein the second coating layer is a thick metal coating layer, a metallic material of the metal coating layer being chosen in particular from nickel (Ni) and its alloys or chromium-forming alloys, a basic element of which is iron (Fe).

16. A stack of SOEC/SOFC type solid oxide cells operating at high temperature, including a plurality of electrochemical cells each consisting of a cathode, an anode and an electrolyte interposed between the cathode and the anode, and a plurality of interconnectors according to claim 1, each arranged between two adjacent ones of the plurality_electrochemical cells.

17. The interconnector according to claim 1, wherein
a width of each slot of at least one hole is around 4.9 mm, and
a height of each tab of at least one hole is around 0.3 mm.

18. The interconnector according to claim 4, wherein
the contact width of each first raised element is equal to 1 mm, and
the contact width of each second raised element is equal to 100 μm,
the height of each first raised element is equal to 350 μm, and
the height of each second raised element is equal to 400 μm.

19. The interconnector according to claim 4, wherein a difference between the height of each second raised element and the height of each first raised element is around 50 μm.

20. The interconnector according to claim 9, wherein the different geometric characteristics include at least one of different heights and different contact widths.
